(19) United States
(12) Patent Application Publication
(10) Pub. No.: US 2026/0161729 A1
(43) Pub. Date: Jun. 11, 2026

(54) DEDICATED CONVOLUTION CORE FOR MACHINE LEARNING BASED IMAGE SUPER RESOLUTION

(71) Applicant: ADVANCED MICRO DEVICES, INC., Santa Clara, CA (US)

(72) Inventors: Zhenyu Xu, Oviedo, FL (US); Jie Zhang, Orlando, FL (US); DaZheng Wang, Shanghai (CN)

(21) Appl. No.: 18/975,290

(22) Filed: Dec. 10, 2024

(51) Int. Cl. G06F 17/15; G06F 7/57; G06F 17/16

(52) U.S. Cl. CPC G06F 17/153; G06F 7/57; G06F 17/16

(57) ABSTRACT

A processing system includes a plurality of single instruction, multiple data (SIMD) units, a memory, and a convolution core. The convolution core performs convolution operations on data fetched from the memory to generate convolved data and transmit the convolved data to the plurality of SIMD units. The plurality of SIMD units executes operations on the convolved data such as operations associated with machine learning based image super resolution (MLSR).

### BACKGROUND

Machine learning based image super resolution (MLSR) upscales lower resolution images to higher resolution images at a higher level of detail and realism than conventional interpolation-based upscaling. In some instances, accelerated processing units (APUs) such as graphics processing units (GPUs), artificial intelligence (AI) accelerators, or other parallel processors perform MLSR by employing a convolutional neural network (CNN). The CNN includes numerous layers that perform convolution operations on the lower resolution input image data, where each convolution operation includes a set of filters that are “convolved” with the input image data to generate an output feature map that is used for image upscaling. Conventional MLSR methods include fetching image data from a memory or cache of an APU's texture pipeline and utilizing the APU's parallel computational units (e.g., single instruction, multiple data (SIMD) units) to execute the convolution operations (also referred to herein as “matrix operations”).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a processing system with an accelerated processing unit (APU) to implement MLSR convolution techniques in a texture pipeline according to some embodiments.

FIG. 2 shows an example of a compute unit, such as one corresponding to one of the compute units of the processing system of FIG. 1, to perform convolution techniques in a texture pipeline for MLSR according to some embodiments.

FIG. 3 shows an example of a process flow for a compute unit to perform convolution techniques in a texture pipeline of an APU according to some embodiments.

FIG. 4 shows an example of a convolution core configured to perform convolution operations on texture data in a texture pipeline according to some embodiments.

FIG. 5 shows an example diagram depicting convolution operations, also referred to herein as matrix operations, executed by a convolution core, such as the convolution core of FIG. 4, in accordance with some embodiments.

FIG. 6 shows an example of timing diagrams for performing the convolution operations of FIG. 5 in accordance with some embodiments.

FIG. 7 shows an example of a process flowchart illustrating a method for performing convolution operations in a texture pipeline of a compute unit according to some embodiments.

### DETAILED DESCRIPTION

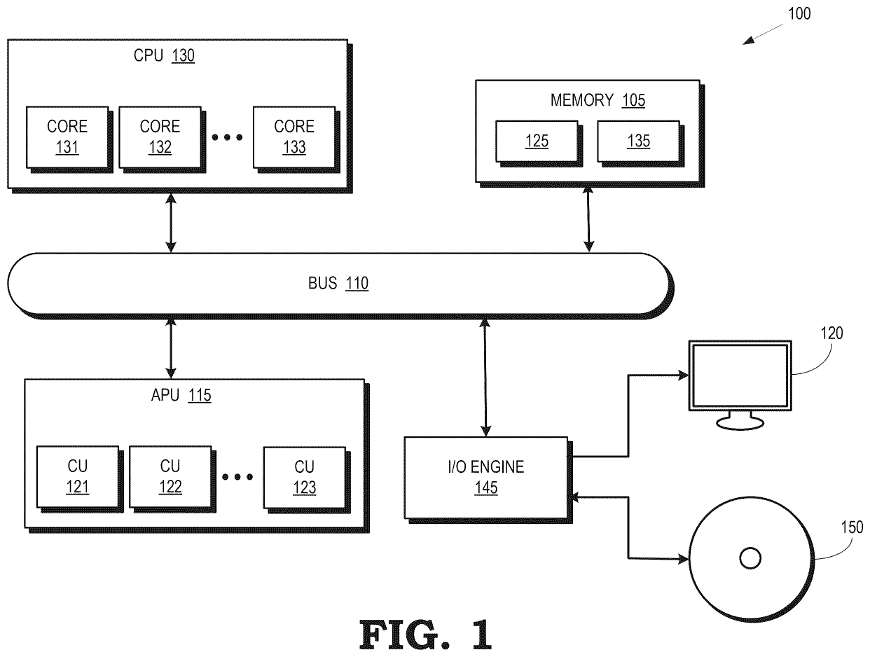

Conventional MLSR methods that fetch data from a memory of the APU's texture pipeline and utilize the APU's SIMD units to execute a CNN's matrix operations suffer from high latencies due to, inter alia, the time it takes to load data from the texture pipeline to the SIMD units. In addition, conventional MLSR methods sometimes generate vector general purpose register (VGPR) usage conflicts in the SIMD units due to the limited capacity of the VGPRs and dependencies between the matrix operations which can stall the arithmetic logic unit (ALU) or other computational unit pipelines in the SIMD units. These factors decrease the runtime performance of the APU when performing MLSR. FIGS. 1-7 introduce a convolution core that is dedicated to performing at least a portion of the MLSR convolution operations in the texture pipeline prior to providing the convolved image data to the SIMD units. This removes the burden of performing the convolution operations from the SIMD units, thereby allowing the SIMD units to run other tasks such as rendering operations or machine learning operations in parallel with the convolution core executing the convolution operations.

To illustrate, in some embodiments, an APU includes a plurality of SIMD units that implement a shader pipeline. Each one of the SIMD units includes one or more ALU pipelines that execute instructions on wavefronts (operands) such as those pertaining to various rendering operations or machine learning operations. The SIMD units include VGPR banks that receive input data from data sources such as a local data share (LDS) or a cache to provide the wavefronts for execution at the ALU pipelines. The APU is configured to fetch data, such as texture data, to the VGPR banks via a texture pipeline that includes one or more texture addressing (TA) blocks, one or more texture cache (TC) blocks, and one or more texture data (TD) blocks. In this manner, the APU implements the texture pipeline to fetch data from a memory or cache and implements the shader pipeline to perform operations such as rendering or machine learning at the SIMD units based on the fetched data. In addition, the APU includes a convolution core in the texture pipeline. For example, in some embodiments, the convolution core is in the TD block and includes hardware, software, or a combination thereof that is dedicated to performing convolution operations on the fetched data prior to providing the data to the SIMD units in the shader pipeline. In this manner, the convolution core allows the SIMD units to execute other operations in parallel with the convolution operations executing on the convolution core, thereby improving the performance of the APU.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., the TA block, the TC block, the TD block, the convolution core, or other components associated with the techniques described herein) represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, or other type of hardcoded or programmable circuit.

FIG. 1 shows an example of a processing system 100 to implement MLSR and other convolution techniques in a texture pipeline according to some embodiments. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory since it is implemented external to the processing units implemented in the processing system 100. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The techniques described herein are, in different embodiments, employed at any of a variety of parallel processors (e.g., accelerated processing units (APUs), vector processors, graphics processing units (GPUs), general-purpose GPUs (GPGPUs), non-scalar processors, highly-parallel processors, artificial intelligence (AI) processors, neural network (NN) accelerators, inference engines, machine learning processors, other multithreaded processing units, and the like). FIG. 1 illustrates an example of a parallel processor, and in particular an accelerated processing unit (APU) 115, in accordance with some embodiments. The APU 115, in some embodiments, is a GPU that renders images for presentation on a display 120. For example, the APU 115 renders objects to produce values of pixels that are provided to the display 120, which uses the pixel values to display an image that represents the rendered objects. The APU 115 includes a plurality of compute units (CU) 121, 122, 123 (collectively referred to herein as “the compute units (CUs) 121-123”) that execute instructions concurrently or in parallel. In some embodiments, each one of the CUS 121-123 includes one or more single instruction, multiple data (SIMD) units, and the CUs 121-123 are aggregated into workgroup processors, shader arrays, shader engines, or the like. The number of CUs 121-123 implemented in the APU 115 is a matter of design choice and some embodiments of the APU 115 include more or fewer compute units than shown in FIG. 1. In some embodiments, the CUS 121-123 are used to implement a graphics or texture pipeline as discussed herein. In some embodiments, the APU 115 is used for general purpose computing. The APU 115 executes instructions such as program code 125 stored in the memory 105 and the APU 115 stores information in the memory 105 such as the results of the executed instructions.

In some embodiments, the APU 115 executes commands and programs for selected functions, such as graphics operations, machine learning operations, and other operations that are particularly suited for parallel processing. For example, the APU 115 is used for executing graphics pipeline operations, such as pixel operations, geometric computations, and rendering an image to a display. In some embodiments, APU 115 also executes compute processing operations (e.g., those operations unrelated to graphics such as video operations, physics simulations, computational fluid dynamics, etc.) based on commands or instructions received from the CPU 130. For example, such commands include special instructions that are not typically defined in the instruction set architecture (ISA) of the APU 115. In some embodiments, the APU 115 receives an image geometry representing a graphics image, along with one or more commands or instructions for rendering and displaying the image. In various embodiments, the image geometry corresponds to a representation of a two-dimensional (2D) or three-dimensional (3D) computerized graphics image.

The processing system 100 also includes a central processing unit (CPU) 130 that is connected to the bus 110 and therefore communicates with the APU 115 and the memory 105 via the bus 110. The CPU 130 implements a plurality of processor cores 131, 132, 133 (collectively referred to herein as “the processor cores 131-133”) that execute instructions concurrently or in parallel. The number of processor cores 131-133 implemented in the CPU 130 is a matter of design choice and some embodiments include more or fewer processor cores than illustrated in FIG. 1. The processor cores 131-133 execute instructions such as program code 135 stored in the memory 105 and the CPU 130 stores information in the memory 105 such as the results of the executed instructions. The CPU 130 is also able to initiate graphics processing by issuing draw calls to the APU 115. Some embodiments of the CPU 130 implement multiple processor cores (not shown in FIG. 1 in the interest of clarity) that execute instructions concurrently or in parallel.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the APU 115, or the CPU 130. In the illustrated embodiment, the I/O engine 145 reads information stored on an external storage component 150, which is implemented using a non-transitory computer readable medium such as a compact disk (CD), flash drive, and the like. The I/O engine 145 is also able to write information to the external storage component 150, such as the results of processing by the APU 115 or the CPU 130.

The processing system 100 implements processing pipeline circuitry for executing instructions in multiple stages of the processing pipeline. The processing pipeline circuitry is implemented in some embodiments of the CUs 121-123 or the processor cores 131-133. In some embodiments, the processing pipeline circuitry is used to implement a graphics pipeline that executes shaders of different types including, but not limited to, vertex shaders, hull shaders, domain shaders, geometry shaders, and pixel shaders. In some embodiments, the processing pipeline circuitry is used to execute operations associated with machine learning based image super resolution (MLSR). Some embodiments of the processing system 100 include a texture addressing processor (TAP), a texture cache processor (TCP), and a texture data processor (TDP) with a dedicated convolution core. For example, the one or more of the CUs in the APU 115 are used to implement the dedicated convolution core as discussed herein.

In various embodiments, processing system 100 is a computer, laptop, mobile device, server, or any of various other types of computing systems or devices. It is noted that the number of components of processing system 100 can vary from embodiment to embodiment. There can be more or fewer of each component or subcomponent than the number shown in FIG. 1. Additionally, in some embodiments, the processing system 100 includes other components that are not shown in FIG. 1 or can be structured in other ways than shown in FIG. 1.

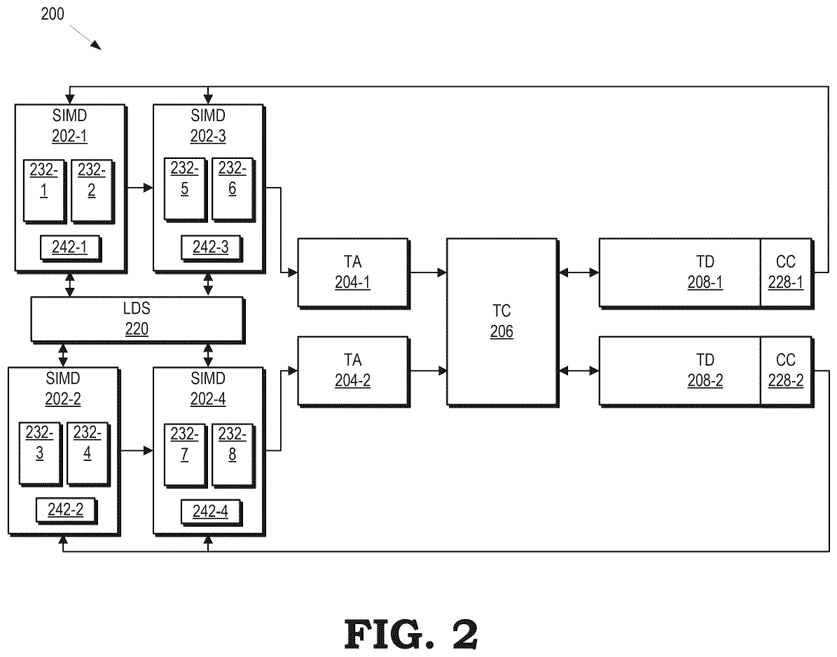

FIG. 2 shows an example of a compute unit 200, such as one corresponding to one of the CUS 121-123 of FIG. 1, to perform convolution operations in a texture pipeline for MLSR according to some embodiments. The compute unit 200, according to some embodiments, includes multiple SIMD units 202 that are each configured to execute a thread (or sequence of work items) concurrently with execution of other threads in a wavefront (or a set of threads) by other SIMD units 202 according to a SIMD execution model. The SIMD execution model is one in which multiple processing elements share a single program control flow unit and program counter and execute the same program but are able to execute that program with different data. Each SIMD unit 202 includes one or more processing elements such as scalar and/or vector floating-point units, arithmetic and logic units (ALUs), and the like. In some cases, the SIMD units 202 also include special purpose processing units.

In some embodiments, the compute unit 200 executes a respective instantiation of a particular work item to process incoming data, where the basic unit of execution in the compute unit 200 is a work item. For example, each work item represents a single instantiation of a collection of parallel executions of a kernel invoked by a command that is to be executed in parallel. To reduce latency associated with off-unit memory access (e.g., at memory 105 of FIG. 1), various compute unit architectures include a memory cache hierarchy including, for example, a local data share (LDS) 220. The LDS 220 is a high-speed, low-latency memory private to compute unit 200 that is accessible by each one of the SIMD units 202.

The parallelism afforded by the multiple compute units (such as the CUS 121-123) including the compute unit 200 in a processing system (such as processing system 100 of FIG. 1) is suitable for graphics related operations (such as pixel value calculations, vertex transformations, tessellation, geometry shading operations, and other graphics operations), machine learning operations, and other computationally intensive operations. For example, the SIMDs 202 of the compute unit 200 are configured to implement a processing pipeline that accepts graphics or machine learning processing commands from a CPU (such as CPU 130 of FIG. 1). That is, in some embodiments, the CPU provides computation tasks to multiple compute units such as the compute unit 200 for execution in parallel. Some pipeline operations, such as pixel processing and other parallel computation operations, require that the same command stream or compute kernel be performed on streams or collections of input data elements. Respective instantiations of a same compute kernel are executed concurrently on multiple SIMD units 202 of the compute unit 200 in order to process such data elements in parallel. As referred to herein, for example, a compute kernel is a function containing instructions in a program and executed on a compute unit such as the compute unit 200. In some cases, this function is also referred to as a kernel, a shader, a shader program, or a program.

In some embodiments, each one of the SIMD units 202 includes one or more processing pipelines 232 that have access to one or more VGPR banks 242. For example, in the illustrated embodiment, the processing pipelines 232 are ALU pipelines including a set of ALUs, and SIMD 202-1 includes ALU pipelines 232-1, 232-2 and VGPR 242-1, SIMD 202-2 includes ALU pipelines 232-3, 232-4 and VGPR 242-2, SIMD 202-3 includes ALU pipelines 232-5, 232-6 and VGPR 242-3, and SIMD 202-4 includes ALU pipelines 232-7, 232-8 and VGPR 242-4. Each of the ALU pipelines 232 includes a number of ALUs or computation units (not shown for clarity purposes). The SIMD units 202 load data from an external data source (e.g., the LDS 220) into the VGPR banks 242 so that the computation units of the ALU pipelines 232 can execute multiple wavefronts according to a SIMD execution model. For example, in some embodiments, the SIMDs 202 are configured to upscale lower resolution image data into higher resolution image data by generating a feature map that is used for MLSR based on lower resolution image data that is loaded into the VGPR banks. In some embodiments, each of ALU pipelines 232 support the same types of wavefront instructions, and in other embodiments, each of the ALU pipelines 232 supports a subset of the types of wavefront instructions supported by another one of the ALU pipelines. The set of VGPR banks 242 receives inputs from sources such as local data share (LDS) data, texture data, and VGPR initialization inputs. In some embodiments, each of the VGPR banks 242 includes N registers, wherein the value of N varies from embodiment to embodiment. The size of the registers in VGPR banks also varies according to the embodiment.

In addition to the SIMD units 202 and the LDS 220, the compute unit 200 includes one or more texture addressing (TA) blocks 204, one or more a texture cache (TC) blocks 206, and one or more texture data (TD) blocks 208 to implement the texture pipeline. The one or more TA blocks 204 are coupled to the SIMD units 202 and send data access requests from the SIMD units 202 to the TC block 206. The TC block 206 filters and formats the information in the requests received from the one or more TA blocks 204 and forwards this information to the one or more TD blocks 208. In some embodiments, the TC block 206 and the TD blocks 208 store the texture access data in RAM until the corresponding data is available for transmitting to the SIMD units 202.

In conventional methods, the TD block sends the texture data to the VGPR banks of the SIMD units, and the SIMD units perform the numerous MLSR convolution operations (e.g., matrix operations) on the data. As such, the conventional methods consume SIMD unit resources that could otherwise be utilized for other computationally intensive tasks such as rendering or machine learning. In addition, conventional methods may generate long latencies when distributing the data from the texture pipeline (e.g., from a TD block) to the VGPR banks since the matrix layout to execute the convolution operations needs to be prepared for operands with different matrix orientations, e.g., different numbers of rows and columns. This may generate frequent data hazards since the matrices occupy multiple VGPRs that may be overlapped for the same or different matrix operations, resulting in dependencies among the matrix operations (e.g., multiple or add operations) that can stall the ALU pipelines in the SIMDs.

The techniques described herein reduce or eliminate the above problems by introducing a convolution core (CC) 228 into the texture pipeline. In the illustrated embodiments, the CC 228 is depicted as being included in one or more of the TD blocks 208. In other embodiments, the CC 228 is located external to the TD block 208. The CC 228 includes hardware that is dedicated to performing convolution operations on the texture data from the TD block 208 and forwarding the convolved texture data to the SIMD units 202. The CC 228 thus frees up the SIMD units' 202 resources (e.g., ALU pipelines 232 or VGPRs 242) to perform other operations and reduces or eliminates the likelihood of ALU pipeline stalls.

Although the compute unit 200 is illustrated as having a particular number of each component in FIG. 2, in other embodiments, there can be more or fewer of each component or subcomponent than the number shown in FIG. 2. Additionally, in some embodiments, the compute unit 200 includes other components that are not shown in FIG. 2 or can be structured in other ways than shown in FIG. 2.

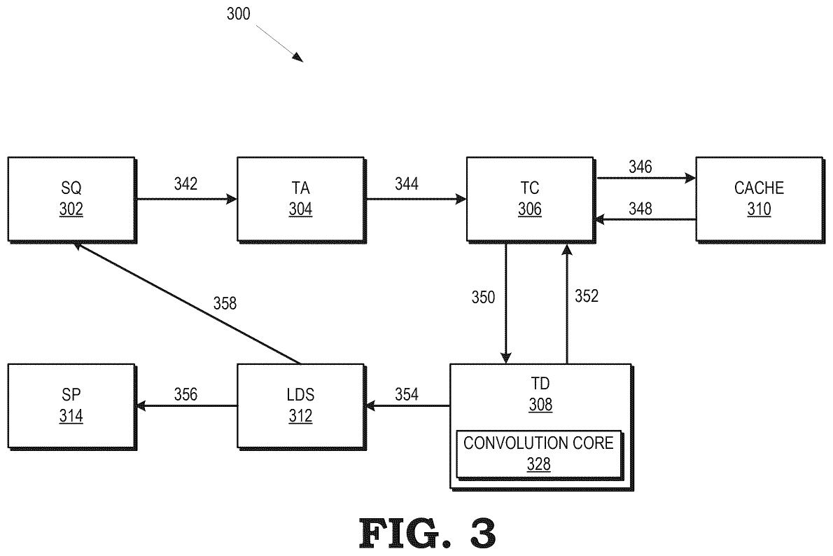

FIG. 3 shows an example of a process flow 300 for a compute unit, such as one of the CUs 121-123 of FIG. 1 or the compute unit 200 of FIG. 2, to implement MLSR convolution techniques in a texture pipeline of an APU according to some embodiments. The process flow 300 illustrates a top-level view and includes similar components to those described above in FIGS. 1 and 2. The components of the process flow 300 includes a shader sequence (SQ) block 302, a shader pipeline (SP) block 314, a texture address (TA) block 304, a texture cache (TC) block 306, a cache memory system 310, a texture data (TD) block 308 with a convolution core 328, and a local data share (LDS) 312.

In some embodiments, one or more ALU pipelines in one or more SIMD units of the compute unit implements the SP block 314 and the SQ block 302. In addition, the TA block 304 corresponds to the TA blocks 204 of FIG. 2, the TC block 306 corresponds to the TC block 206 of FIG. 2, the TD block 308 corresponds to the TD blocks 208 of FIG. 2, the convolution core 328 corresponds to the CCs 228 of FIG. 2, and the LDS 312 corresponds to the LDS 220 of FIG. 2. The cache memory system 310 includes one or more levels of cache memory (e.g., Level 1 (L1) or Level 2 (L2) cache) of the APU.

In the illustrated embodiment, at arrow 342, the SQ block 302 parses convolution instructions and sends a command with the parsed convolution instructions to the TA block 304. For example, the SQ block 302 receives the convolution instructions from another component in an APU (e.g. APU 115 of FIG. 1), from a CPU (e.g., CPU 130 of FIG. 1), or from another element in a processing system (e.g., processing system 100 of FIG. 1). In some instances, the SQ block 302 sends the command in a virtual memory command format. For example, in some embodiments, the SQ block 302 supports convolution instructions in one or more of the following formats: half-precision (16-bit) floating-point (fp16) format, 8-bit integer (int8) format, or 4-bit integer (int4) format. In some embodiments, the convolution instructions issued by the SQ block 302 at arrow 342 include multiple fields to indicate one or more of: one or more input matrix buffer resources for one or more input matrices to fetch from the cache memory system 310, an output matrix buffer resource to store results from the convolution operations performed by the convolution core 328, an offset for each of the one or more input matrices to indicate a row and column of the respective input matrices to be utilized in the convolution operations, and a VGPR indicator to show if the result of the convolution operations will be written to a VGPR and to which VGPR the result is to be written to. In some embodiments, different rows in a first matrix and different columns in a second matrix are sent to different TD blocks (e.g., to TD blocks 208-1, 208-2 of FIG. 2) to be executed in parallel.

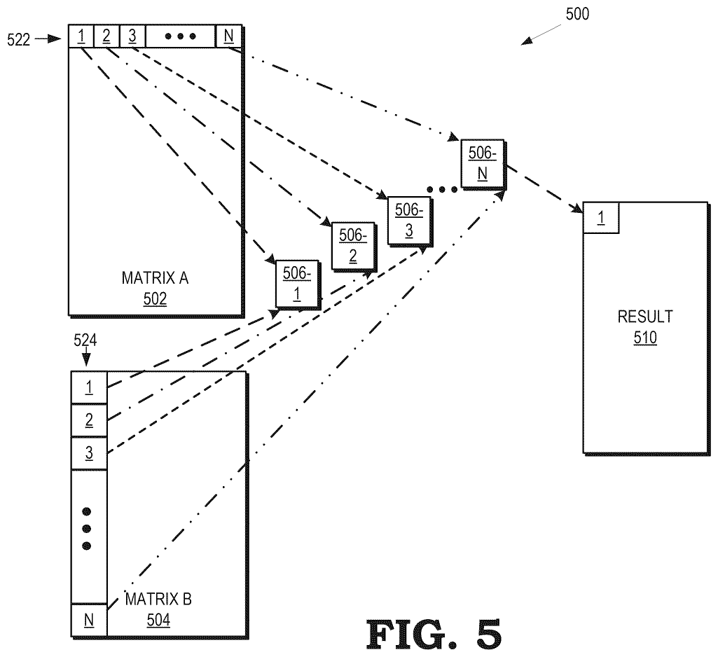

At arrow 344, the TA block 304 calculates an address per thread associated with the convolution instructions received from the SQ block 302 based on a resource descriptor and an offset and forwards this information to the TC block 306. For example, in some embodiments, the TA block 304 supports calculating a real virtual address and read size based on the descriptor and the offsets indicated in the convolution instructions in the command received from the SQ block 302. In response to the information received from the TA block 304 at arrow 344, the TC block 306 at arrow 346 requests the data (e.g., texture data in a matrix format) from the cache memory system 310, which returns the requested data at arrow 348. At arrow 350, the TC block 306 forwards the data from the cache memory system 310 to the TD block 308. For example, in some embodiments, the data includes texture data stored in a matrix A and a matrix B, and the Mth row of a matrix A and the Nth column of a matrix B are transmitted from the cache memory system 310 to the TD block 308. Inside the TD block 308, the convolution core 328 performs matrix operations on the data. For example, the convolution core 328 performs dot operations on the elements of the Mth row of matrix A and the elements of the Nth column of matrix B and then adds the dot operation products together to get a sub-matrix result (described in further detail in FIG. 5), where the sub-matrix result corresponds to the convolved data. The TD block 308 then transmits the convolved data to the LDS 312 at arrow 354. In some cases, at arrow 352, the TD block 308 alternatively or additionally sends the convolved data back to the TC block 306 for returning back to the cache memory system 310. In the case that the TD block 308 sends the convolved data to the LDS 312, the LDS 312 forwards the convolved data to the SP block 314 at arrow 356 or to the SQ block 302 at arrow 358. For example, the LDS 312 transmits the convolved data to the SP block 314 at arrow 356 for further operations such as max pooling or sampling and, in some cases, may be based on a command destination selection from the command at arrow 342.

Thus, by implementing the convolution core 328 in the texture pipeline as illustrated in process flow 300, the compute unit is able to perform the convolution operations in the convolution core 328 at the same time the SIMD units in the SP block 314 are executing other machine learning or rendering MLSR operations, thereby improving the overall performance of the compute unit and the APU housing the compute unit.

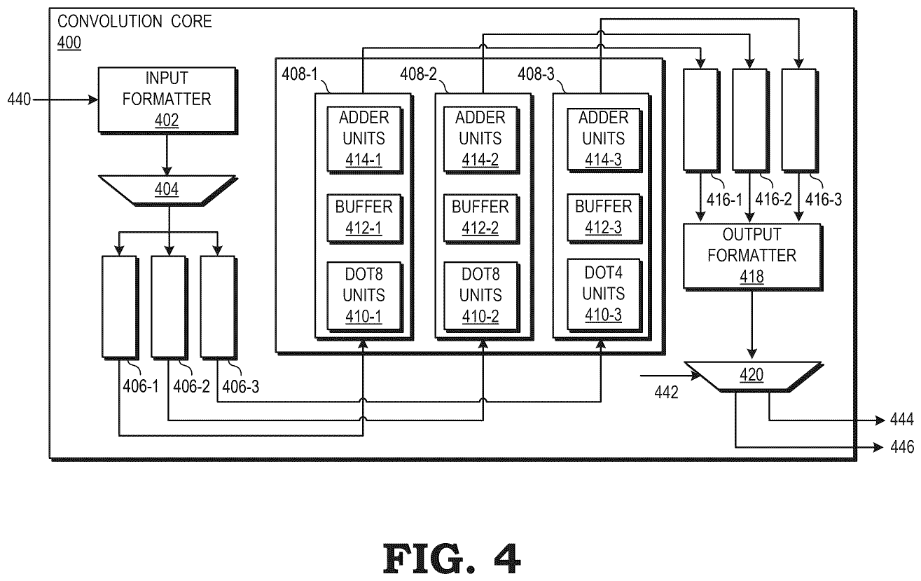

FIG. 4 shows an example of a convolution core 400 configured to perform convolution operations on texture data in a texture pipeline according to some embodiments. The convolution core 400, in some cases, is one of the CC 228 of FIG. 2 or the convolution core 328 of FIG. 3.

In the illustrated embodiment, the convolution core 400 includes input formatting circuitry referred to herein as an input formatter 402 (also herein referred to as “input formatting circuitry”) to buffer and align input data 440 into a format for one or more of the processing pipelines 408. The input formatter 402 receives the input data 440 from the cache memory system (such as cache memory system 310 of FIG. 3, not shown in FIG. 4 for clarity purposes) via a TC block (such as TC block 306 of FIG. 3, not shown in FIG. 4 for clarity purposes). For example, the input data 440, in some embodiments, includes a 1024 bit data width and the output of the input formatter 402 includes a 512 bit data width in one or more data formats such as int4, int8, or fp16 data formats. The convolution core 400 also includes a demultiplexer 404 that generates one or more output signals according to the one or more data formats. For example, in some embodiments, the demultiplexer 404 generates one or more of a first signal with an int4 data format, a second signal with an int8 data format, and a third signal with an fp16 data format for a respective first in, first out (FIFO) queue 406. That is, in some embodiments, a first FIFO queue 406-1 is an int4 data format FIFO queue, a second FIFO queue 406-2 is an int8 data format FIFO queue, and a third FIFO queue 406-3 is an fp16 data format FIFO queue. Each one of the respective FIFO queues 406 buffers the data received from the input formatter 402 via demultiplexer 404 and outputs the data at a particular bit width, e.g., at a 512 bit data width, to a respective one of the processing pipelines 408 with computational units (e.g., floating-point units (FPUs) or ALUs).

In some embodiments, the processing pipelines 408 are ALU pipelines. Each one of the ALU pipelines 408 includes ALU units for performing matrix operations on a respective one of the data formats. In the illustrated embodiment, the first ALU pipeline 408-1 includes multiple int4 dot8 units 410-1 to perform matrix multiplications (e.g., multiplication operations) on the data output from the first FIFO queue 406-1, a buffer 412-1 to store the products of the int4 dot8 units 410-1, and multiple int4 adder units 414-1 to perform matrix additions (e.g., addition operations) on the data from the buffer 412-1. For example, in the case that the data input to ALU pipeline 408-1 has a 512 bit data width, the ALU pipeline 408-1 includes 128 int4 dot8 units 410-1 and 128 int4 adder units 414-1. The second ALU pipeline 408-2 includes multiple int8 dot8 units 410-2 to perform matrix multiplications (e.g., multiplication operations) on the data output from the second FIFO queue 406-2, a buffer 412-2 to store the products of the int8 dot8 units 410-2, and multiple int4 adder units 414-2 to perform matrix additions (e.g., addition operations) on the data from the buffer 412-2. For example, in the case that the data input to ALU pipeline 408-2 has a 512-bit data width, the ALU pipeline 408-2 includes 64 int4 dot8 units 410-2 and 64 int4 adder units 414-2. The third ALU pipeline 408-3 includes multiple fp16 dot4 units 410-3 to perform matrix multiplications (e.g., multiplication operations) on the data output from the third FIFO queue 406-3, a buffer 412-3 to store the products of the fp16 dot4 units 410-3, and multiple fp16 adder units 414-3 to perform matrix additions (e.g., addition operations) on the data from the buffer 412-3. For example, in the case that the data input to ALU pipeline 408-3 has a 512-bit data width, the ALU pipeline 408-3 includes 32 fp16 dot4 units 410-3 and 32 fp16 adder units 414-3. An example of the matrix operations performed by the components of the ALU pipelines 408 is shown in more detail below in FIG. 5.

Thus, in this manner, the ALU pipelines 408 include components to perform matrix operations (also referred to as convolution operations) on the input data 440 to generate convolved data. Each one of the ALU pipelines 408 outputs the convolved data to a respective output buffer 416. That is, the first ALU pipeline 408-1 outputs its convolved data to a first output buffer 416-1, the second ALU pipeline 408-2 outputs its convolved data to a second output buffer 416-2, and the third ALU pipeline 408-3 outputs its convolved data to a third output buffer 416-3. The output buffers 416 buffer the received data from the ALU pipelines 408 and output the buffered data to output formatting circuitry referred to herein as an output formatter 418. The output formatter 418 realigns the data to a 1D or 2D addressing mode data than can be output to a TC block, a LDS, or VGPR banks in SIMD units as described above in FIG. 3. For example, in some embodiments, the output formatter 418 realigns the data from a 512 bit data width to a 1024 bit data width. In some embodiments, the convolution core 400 also includes a selector 420 to selectively output the convolved data to a shader pipeline 444 (e.g., to the LDS 312 or to the VGPR banks of the SP block 314 of FIG. 3) or to a TC block 446 (e.g., to TC block 306 of FIG. 3) based on a command destination selection input 442. For example, the command destination selection input 442 is included in the command from a shader sequence block such as the arrow 342 from the SQ block 302 of FIG. 3.

By introducing the convolution core 400 to the texture pipeline of a compute unit in an APU, the convolution core 400 removes the burden of performing convolution operations on texture data from the SIMD units of the compute unit during MLSR, thereby freeing up the resources of the SIMD units to perform other rendering or machine learning operations.

FIG. 5 shows an example diagram 500 depicting convolution operations (also referred to herein as matrix operations) executed by a convolution core, such as the convolution core 400 of FIG. 4, in accordance with some embodiments.

In the illustrated embodiment, the convolution core performs convolution operations on two texture data matrixes, Matrix A 502 and Matrix B 504, that are selected from a cache memory system based on convolution instructions issued from a SQ block such the convolution instructions in the command at arrow 342 issued by the SQ block 302 of FIG. 3. That is, each one of Matrix A 502 and Matrix B 504 are representative of texture data that a TC block (such as TC block 306 of FIG. 3) retrieves from a cache memory system (such as cache memory system 310 of FIG. 3) and forwards to the convolution core (such as convolution core 328 of FIG. 3 or convolution core 400 of FIG. 4). The convolution core 400 selects a row 522 from the Matrix A 502 based on a first offset in the convolution instructions in the command from the SQ block and selects a column 524 based on a second offset in the convolution instructions in the command from the SQ block. The multiply units of the ALU pipeline of the convolution core (e.g., the multiply, or the respective dot8/dot4, units 410 of the ALU pipelines 408 of the convolution core 400 of FIG. 4) perform matrix multiplication operations on the data elements of Matrix A 502 and Matrix B. For example, the multiply units of the ALU pipeline multiply a first element of row 522 of Matrix A 502 by a first element of a column 524 of Matrix B 504 to generate a first product 506-1, a second element of row 522 of Matrix A 502 by a second element of a column 524 of Matrix B 504 to generate a second product 506-2, a third element of row 522 of Matrix A 502 by a third element of a column 524 of Matrix B 504 to generate a third product 506-3, and so on until the last element, N, in the row 522 of Matrix A 502 and the column 524 of Matrix B 504. A buffer (such as one of the buffers 412 of FIG. 4) stores the products 506 of the matrix multiplication operations. Then, the adder units of the ALU pipeline (such as the adder units 414 of FIG. 4) add the products 506 together and store the resulting sum in a first element of a result matrix 510, which is representative of the convolved data of the convolution core. In some embodiments, this process is repeated for other rows/columns of Matrix A and Matrix B and/or for other matrices. In this example, the result portion 510-1 of the result matrix 510 is an 8×8 matrix for int8 and int4 data formats and is a 4×4 matrix for fp16 data formats.

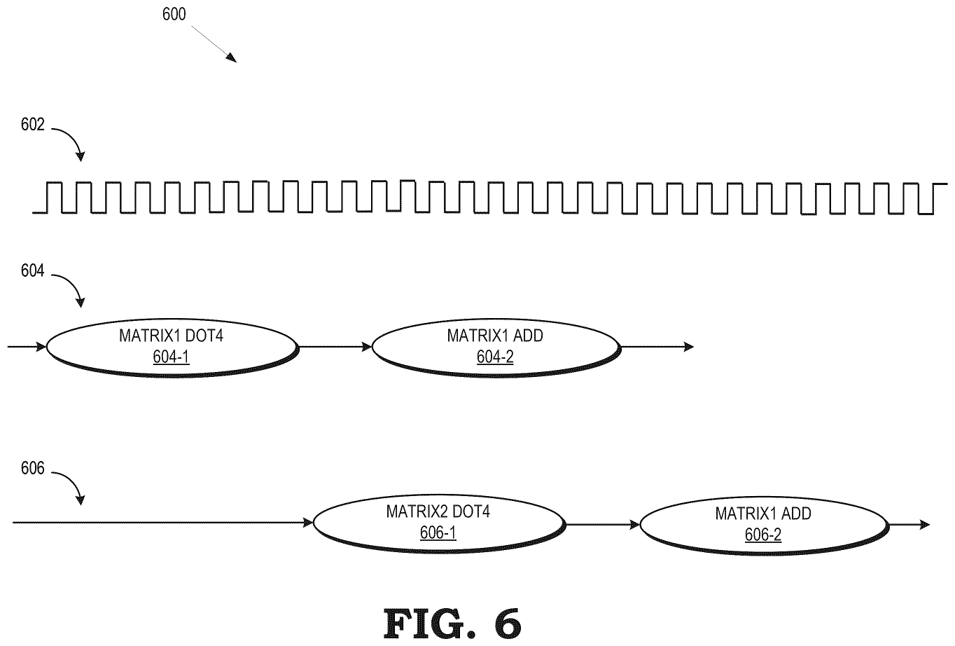

FIG. 6 shows an example of a timing chart 600 with diagrams 602, 604, 606 illustrating the matrix operations, such as the operations illustrated in FIG. 5, executed by an ALU pipeline in a convolution core, such as one of the ALU pipelines 408 in convolution core 400 of FIG. 4, in accordance with some embodiments. Diagram 602 illustrates the clock cycles of the ALU pipeline, diagram 604 illustrates a first matrix operation iteration through the ALU pipeline, and diagram 606 illustrates a second matrix operations iteration through the ALU pipeline. The illustrated embodiment shows the timing diagrams for an fp16 data format, but in other embodiments, similar concepts to those described with respect to the fp16 data format apply to other data formats.

In some embodiments, the number of dot (i.e., multiply) units and adder units in the ALU pipelines (e.g., ALU pipelines 408 of FIG. 4) are based on the memory return interface width and the matrix size of the data retrieved from the cache memory system. In some cases, the number of ALU units in the ALU pipelines is selected to cover the latency of the convolution operations and to minimize the area of the convolution core. For instance, in one example, a row for a first matrix (e.g., Matrix A 502 of FIG. 5) has an 18×4×4 matrix, while a column for a second matrix (e.g., Matrix B 504 of FIG. 5) has a similarly sized matrix. For an fp16 data format, the data that is input to the convolution core from the TC block (e.g., input data 440 of FIG. 4) to get the result for one matrix is 18×4×4×2B×2=1152B. If the return bus is 128B wide, the data is transferred in 10 cycles. For the calculation for one matrix, 18×16 dot4 fp16 operations are needed, and 18 matrixes are required to be added together by the adder units of the ALU pipeline. As such, in some embodiments, the ALU pipeline to perform these operations includes 32 fp16 dot4 units and 32 fp16 adder units. Ideally, the total number of cycles to compute one 4×4 matrix is 18×16/32+(18−1)×16/32, or 18 cycles. In some embodiments, additional flops are inserted between the dot4 and adder units (i.e., as shown between Matrix 1 Dot4 604-1 and Matrix 1 Add 604-2 or between Matrix2 Dot4 606-1 and Matrix2 Add 606-2). Once the dot4 units are freed from the previous matrix and moved to the buffer, the next matrix calculation can use the dot4 units. For example, once the Matrix 1 Dot4 604-1 operations are complete, the Matrix2 Dot4 606-1 operations can be started. In diagrams 604, 606, the respective inputs are received from the input buffer (e.g., a respective FIFO queue 406 of FIG. 4) and the respective outputs are sent to the output formatter (e.g., the output formatter 418 of FIG. 4).

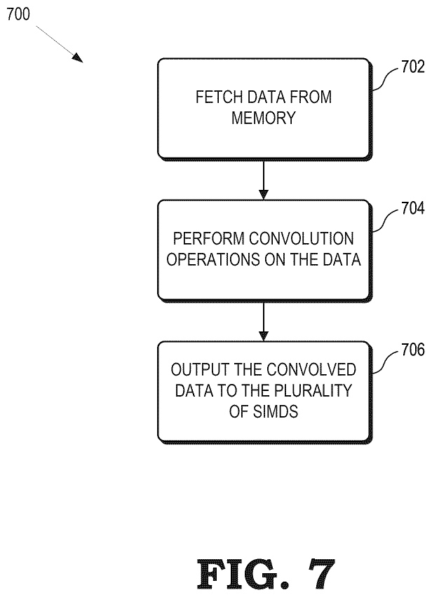

FIG. 7 shows a process flowchart 700 illustrating a method for performing convolution operations in a texture pipeline in a compute unit according to some embodiments. For example, the convolution operations are performed in the texture pipeline of a compute unit for executing MLSR. At 702, the texture pipeline fetches texture data from a memory to a convolution core. For example, a TC block such as the TC block 306 of FIG. 3 fetches data from a cache memory system such as the cache memory system 310 and transmits the data to a convolution core in a TD block such as the convolution core 328 in the TD block 308 of FIG. 3. At 704, the convolution core, such as the convolution core 328 of FIG. 3 or the convolution core 400 of FIG. 4, performs convolution operations (also referred to as matrix operations), such as the operations described in FIGS. 5 and 6, on the data received at block 702. At 706, the convolution core 328, 400 outputs the convolved data generated at block 704 to a plurality of SIMD units of the compute unit.

In some embodiments, the apparatus and techniques described above are implemented in a system including one or more integrated circuit (IC) devices (also referred to as integrated circuit packages or microchips), such as the APUs described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An accelerated processing unit comprising:
a convolution core comprising:
one or more processing pipelines to perform convolution operations on data fetched from a memory to generate convolved data,
wherein the convolution core transmits the convolved data to a plurality of single instruction, multiple data (SIMD) units of the accelerated processing unit.

2. The accelerated processing unit of claim 1, wherein the plurality of SIMD units are to execute operations on the convolved data, wherein the operations comprise rendering operations.

3. The accelerated processing unit of claim 1, wherein the plurality of SIMD units are to execute operations on the convolved data, wherein the operations comprise machine learning operations.

4. The accelerated processing unit of claim 1, wherein the accelerated processing unit is implemented in a graphics processing unit (GPU).

5. The accelerated processing unit of claim 1, wherein the convolution core comprises:
input formatting circuitry to buffer the data fetched from the memory and output the data in one or more data formats; and
wherein the one or more processing pipelines comprise one or more arithmetic logic unit (ALU) pipelines, each one of the one or more ALU pipelines to perform operations on at least one data format of the one or more data formats.

6. The accelerated processing unit of claim 5, further comprising:
one or more first in, first out (FIFO) queues, each one of the one or more FIFO queues to:
receive data in one data format of the one or more data formats output from the input formatting circuitry; and
output data to a corresponding one of the one or more ALU pipelines.

7. The accelerated processing unit of claim 5, wherein each one of the one or more ALU pipelines comprises:
a plurality of multiply units to perform matrix multiplication operations on one of the one or more data formats;
a buffer to receive an output from the plurality of multiply units; and
a plurality of adder units to perform addition operations on an output from the buffer.

8. The accelerated processing unit of claim 5, wherein the one or more data formats comprises a 4-bit integer (int4) data format.

9. The accelerated processing unit of claim 5, wherein the one or more data formats comprises an 8-bit integer (int8) data format.

10. The accelerated processing unit of claim 5, wherein the one or more data formats comprises a half-precision (16-bit) floating-point (fp16) data format.

11. The accelerated processing unit of claim 5, further comprising:
one or more output buffers, each one of the one or more output buffers to receive an output from one of the one or more ALU pipelines.

12. The accelerated processing unit of claim 11, further comprising:
output formatting circuitry configured to receive outputs from the one or more output buffers, buffer the outputs received from the one or more output buffers, and generate an output comprising data in at least one data format of the one or more data formats.

13. The accelerated processing unit of claim 12, wherein the output generated by the output formatting circuitry comprises a 1D or a 2D addressing mode data for outputting to a texture cache (TC), a local data share (LDS), or a vector general purpose register (VGPR) of the accelerated processing unit.

14. A processing system comprising:
a plurality of single instruction, multiple data (SIMD) units;
a memory; and
a convolution core comprising:
one or more processing pipelines to perform convolution operations on data fetched from the memory to generate convolved data,
wherein the convolution core transmits the convolved data to the plurality of SIMD units,
wherein the plurality of SIMD units is to execute operations on the convolved data.

15. The processing system of claim 14, further comprising:
a processor to load data from the memory and forward the data to the convolution core,
wherein the convolution core is coupled to the processor.

16. The processing system of claim 15, wherein a local data share (LDS) of the processing system outputs the convolved data from the convolution core to a shader pipeline comprising the plurality of SIMD units.

17. The processing system of claim 14, wherein the plurality of SIMD units performs other operations while the convolution core is performing the convolution operations on the data fetched from the memory to generate the convolved data.

18. The processing system of claim 14, wherein the convolution core comprises:
input formatting circuitry to buffer the data fetched from the memory and output the data in one or more data formats;
one or more arithmetic logic unit (ALU) pipelines as the one or more processing pipelines, each one of the one or more ALU pipelines configured to perform operations on at least one data format of the one or more data formats;
one or more output buffers, each one of the one or more output buffers to receive an output from one of the one or more ALU pipelines; and
output formatting circuitry configured to receive outputs from the one or more output buffers, buffer the outputs received from the one or more output buffers, and generate an output comprising data in at least one data format of the one or more data formats.

19. A method comprising;
fetching, by a convolution core in a processing system, data from a memory;
performing, by one or more processing pipelines in the convolution core, convolution operations on the data to generate convolved data; and
transmitting, by the convolution core, the convolved data to a plurality of single instruction, multiple data (SIMD) units.

20. The method of claim 19, further comprising:
executing, by the plurality of SIMD units, operations on the convolved data received from the convolution core.
